(19) United States
(12) Patent Application Publication
(10) Pub. No.: US 2022/0039323 A1
(43) Pub. Date: Feb. 10, 2022

(54) Wreath Tension Rod System

(71) Applicant: Anthony E. Nonte, Washington, IN (US)

(72) Inventor: Anthony E. Nonte, Washington, IN (US)

(21) Appl. No.: 16/987,013

(22) Filed: Aug. 6, 2020

(51) Int. Cl. A01G 5/04; F16M 13/02

(52) U.S. Cl. CPC A01G 5/04; F16M 13/022

(57) ABSTRACT

A wreath tension rod system for easily mounting a wreath in a window includes an extension rod apparatus and a wreath clip apparatus. The extension rod apparatus comprises an outer rod having an outer rod first end, an outer rod second end, and an outer rod sidewall. An inner rod is coupled to the outer rod. The inner rod has an inner rod first end, an inner rod second end, and an inner rod sidewall. The inner rod first end is slidably coupled within the outer rod first end. A compression spring has a spring mount coupled to the inner rod first end and a spring body coupled to the spring mount. A spring receiver is coupled to the outer rod sidewall and receives the spring body. The wreath clip apparatus is selectively engageable with the extension rod apparatus to secure a wireframe of a wreath.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wreath mounting systems and more particularly pertains to a new wreath mounting system for easily mounting a wreath in a window.

### (2) Description of Related Art including Information Disclosed Under 37 CFR 1.97 and 1.98

The prior art relates to wreath mounting systems. Known devices typically include a hook and a catch to go on top of a door or window. These devices do not serve for use in a display window that does not open. Existing systems do not utilize an expansion bar to extend across a window box allowing for mounting without a window frame, a door frame, or suction cups on the glass.

### BRIEF SUMMARY OF THE INVENTION

An embodiment of the disclosure meets the needs presented above by generally comprising an extension rod apparatus and a wreath clip apparatus. The extension rod apparatus comprises an outer rod having an outer rod first end, an outer rod second end, and an outer rod sidewall. An inner rod is coupled to the outer rod. The inner rod has an inner rod first end, an inner rod second end, and an inner rod sidewall. The inner rod first end is slidably coupled within the outer rod first end. A first end stopper is coupled to the outer rod second end. A second end stopper is coupled to the inner rod second end. A compression spring is coupled to the inner rod. The compression spring has a spring mount coupled to the inner rod first end and a spring body coupled to the spring mount. A spring receiver is coupled to the outer rod. The spring receiver is coupled to the outer rod sidewall and receives the spring body. The wreath clip apparatus is selectively engageable with the extension rod and configured to secure a wireframe of a wreath.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a wreath tension rod system according to an embodiment of the disclosure.

FIG. 2 is a side elevation view of an embodiment of the disclosure.

FIG. 3 is a cross-sectional view of an embodiment of the disclosure along the line 3-3 of FIG. 2.

FIG. 4 is an isometric view of an embodiment of the disclosure.

FIG. 5 is an in-use view of an embodiment of the disclosure.

### DETAILED DESCRIPTION OF THE INVENTION

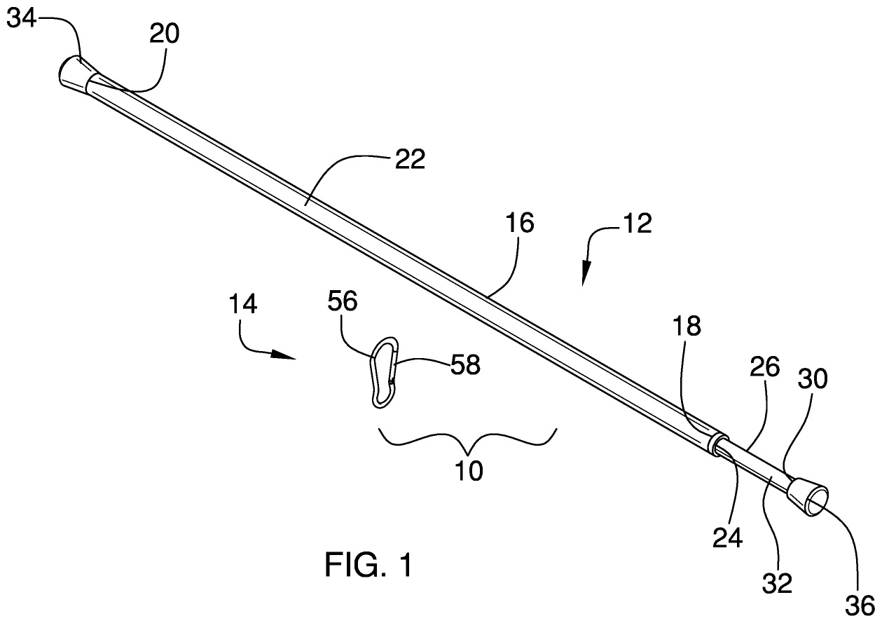

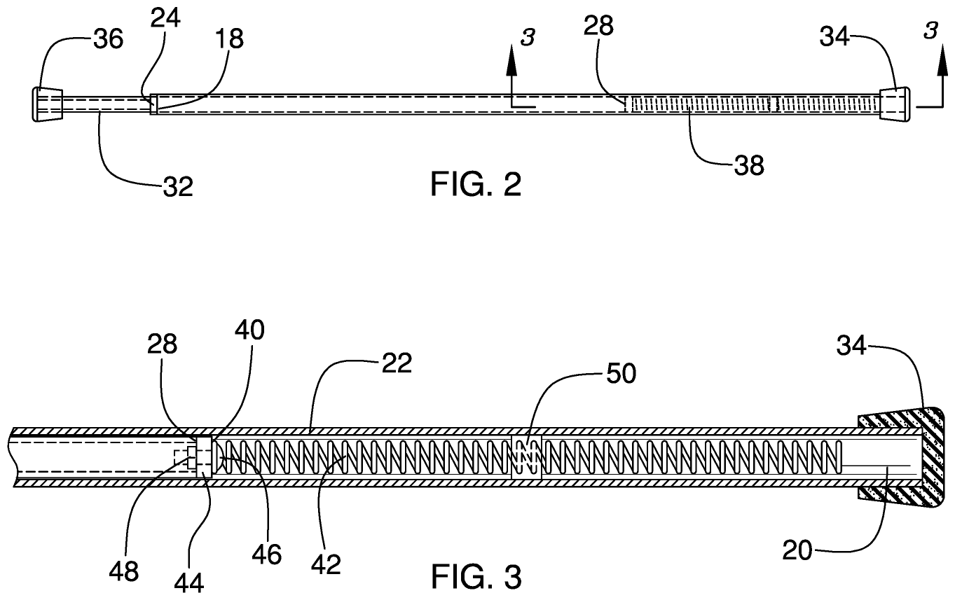

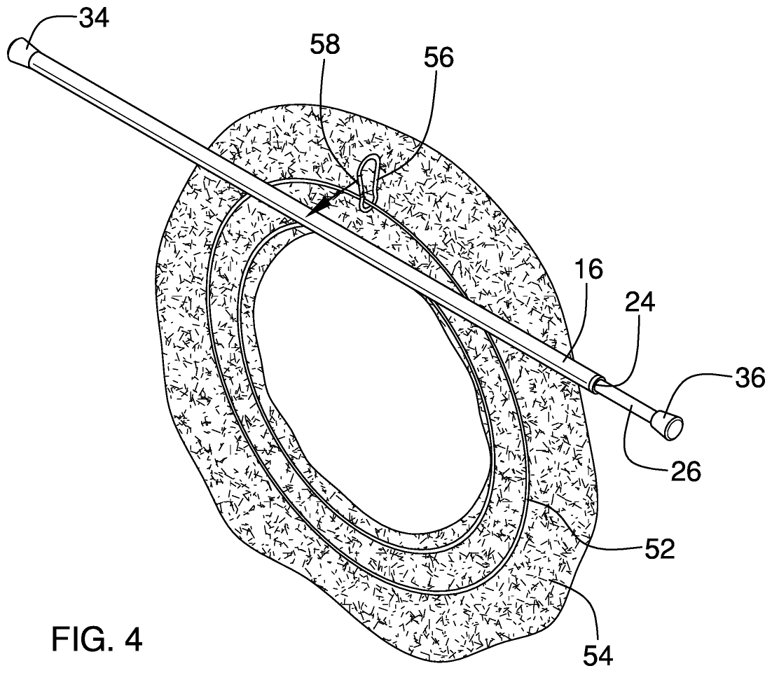

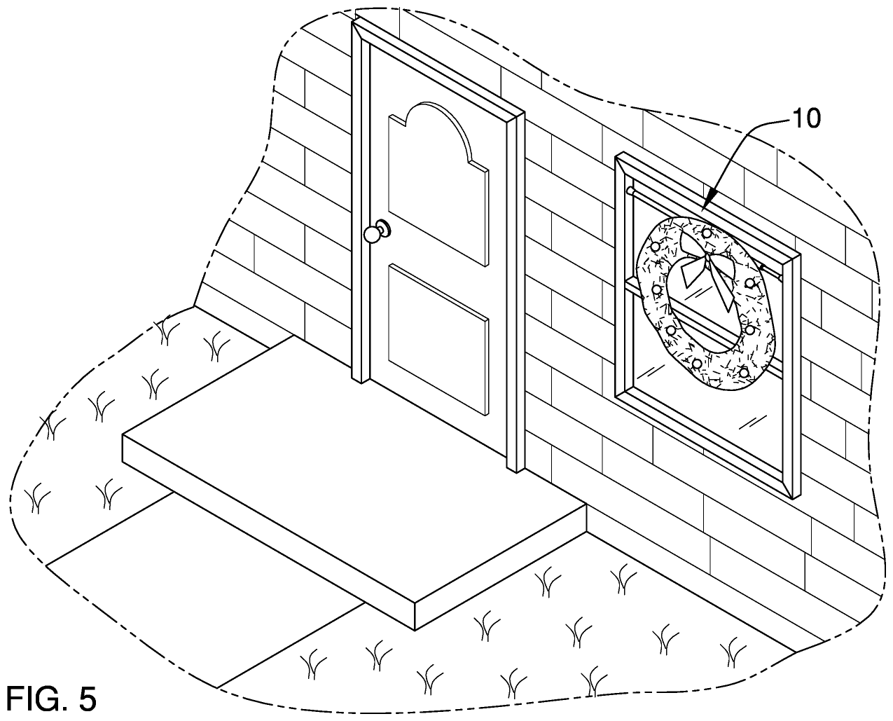

With reference now to the drawings, and in particular to FIGS. 1 through 5 thereof, a new wreath mounting system embodying the principles and concepts of an embodiment of the disclosure and generally designated by the reference numeral 10 will be described.

As best illustrated in FIGS. 1 through 5, the wreath tension rod system 10 generally comprises an extension rod apparatus 12 and a wreath clip apparatus 14. The extension rod apparatus 12 comprises an outer rod 16 having an outer rod first end 18, an outer rod second end 20, and an outer rod sidewall 22. The outer rod first end 18 may have a receiving ring 24. The receiving ring 24 has a smaller diameter than the outer rod 16.

An inner rod 26 is coupled to the outer rod 16. The inner rod 26 has an inner rod first end 28, an inner rod second end 30, and an inner rod sidewall 32. The inner rod first end 28 is slidably coupled within the outer rod first end 18. The receiving ring 24 snugly receives the inner rod 26 to prevent contact between the inner ring sidewall 32 and the outer rod sidewall 22.

A first end stopper 34 is coupled to the outer rod second end 20 and a second end stopper 36 is coupled to the inner rod second end 30. Each of the first end stopper 34 and the second end stopper 36 may be truncated cones. Each of the first end stopper 34 and the second end stopper 36 may be an elastically deformable rubberized material to prevent damage to surfaces.

A compression spring 38 is coupled to the inner rod 26. The compression spring 38 has a spring mount 40 coupled to the inner rod first end 28 and a spring body 42 coupled to the spring mount 40. The spring mount 40 may include a disc portion 44, a bolt portion 46 extending through the disc portion 44, and a nut portion 48 coupled to the bolt portion 46. The bolt portion 46 secures the spring body 42 to the disc portion 44.

A spring receiver 50 is coupled to the outer rod 16. The spring receiver 50 is coupled within the outer rod sidewall 22 and is threaded to twistingly receive the spring body 42. The spring body 42 is thus compressible between the spring mount 48 and the spring receiver 50. By twisting the inner rod 26 the user may adjust an overall length of the extension rod apparatus 12.

The wreath clip apparatus 14 is selectively engageable with the extension rod apparatus 12 and secures a wireframe 52 of a wreath 54. The wreath clip apparatus 14 may comprise a fixed portion 56 and a pivotable portion 58. The pivotable portion 58 may be spring-loaded.

In use, the user adjusts the overall length of the extension rod apparatus 12 to be slightly larger than the desired window box or window frame 60. The compression spring 38 is then compressed to fit each of the first end stopper 34 and the second end stopper 36 within the window frame 60. The wreath clip apparatus 14 is then used to attach the wreath 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wreath tension rod system comprising:
an extension rod apparatus comprising:
an outer rod having an outer rod first end, an outer rod second end, and an outer rod sidewall;
an inner rod coupled to the outer rod, the inner rod having an inner rod first end, an inner rod second end, and an inner rod sidewall, the inner rod first end being slidably coupled within the outer rod first end;
a first end stopper coupled to the outer rod second end;
a second end stopper coupled to the inner rod second end;
a compression spring coupled to the inner rod, the compression spring having a spring mount coupled to the inner rod first end and a spring body coupled to the spring mount; and
a spring receiver coupled to the outer rod, the spring receiver being coupled to the outer rod sidewall and receiving the spring body; and
a wreath clip apparatus, the wreath clip apparatus being selectively engageable with the extension rod apparatus and configured to secure a wireframe of a wreath.

2. The wreath tension rod system of claim 1 further comprising the spring receiver being threaded to twistingly receive the spring body.

3. The wreath tension rod system of claim 1 further comprising the wreath clip apparatus comprising a fixed portion and a pivotable portion.

4. The wreath tension rod system of claim 3 further comprising the pivotable portion being spring-loaded.

5. The wreath tension rod system of claim 1 further comprising the outer rod first end having a receiving ring, the receiving ring having a smaller diameter than the outer rod.

6. The wreath tension rod system of claim 1 further comprising each of the first end stopper and the second end stopper being truncated cones.

7. The wreath tension rod system of claim 1 further comprising the spring mount having a disc portion, a bolt portion extending through the disc portion, and a nut portion coupled to the bolt portion, the bolt portion securing the spring body to the disc portion.

8. A wreath tension rod system comprising:
an extension rod apparatus comprising:
an outer rod having an outer rod first end, an outer rod second end, and an outer rod sidewall, the outer rod first end having a receiving ring, the receiving ring having a smaller diameter than the outer rod;
an inner rod coupled to the outer rod, the inner rod having an inner rod first end, an inner rod second end, and an inner rod sidewall, the inner rod first end being slidably coupled within the outer rod first end;
a first end stopper coupled to the outer rod second end;
a second end stopper coupled to the inner rod second end, each of the first end stopper and the second end stopper being truncated cones;
a compression spring coupled to the inner rod, the compression spring having a spring mount coupled to the inner rod first end and a spring body coupled to the spring mount, the spring mount having a disc portion, a bolt portion extending through the disc portion, and a nut portion coupled to the bolt portion, the bolt portion securing the spring body to the disc portion; and
a spring receiver coupled to the outer rod, the spring receiver being coupled to the outer rod sidewall and being threaded to twistingly receive the spring body; and
a wreath clip apparatus, the wreath clip apparatus being selectively engageable with the extension rod apparatus and configured to secure a wireframe of a wreath, the wreath clip apparatus comprising a fixed portion and a pivotable portion, the pivotable portion being spring-loaded.

9. A wreath tension rod system comprising:
a wreath, the wreath having a wireframe;
an extension rod apparatus comprising:
an outer rod having an outer rod first end, an outer rod second end, and an outer rod sidewall, the outer rod first end having a receiving ring, the receiving ring having a smaller diameter than the outer rod;
an inner rod coupled to the outer rod, the inner rod having an inner rod first end, an inner rod second end, and an inner rod sidewall, the inner rod first end being slidably coupled within the outer rod first end;
a first end stopper coupled to the outer rod second end;
a second end stopper coupled to the inner rod second end, each of the first end stopper and the second end stopper being truncated cones;
a compression spring coupled to the inner rod, the compression spring having a spring mount coupled to the inner rod first end and a spring body coupled to the spring mount, the spring mount having a disc portion, a bolt portion extending through the disc portion, and a nut portion coupled to the bolt portion, the bolt portion securing the spring body to the disc portion; and
a spring receiver coupled to the outer rod, the spring receiver being coupled to the outer rod sidewall and being threaded to twistingly receive the spring body; and
a wreath clip apparatus, the wreath clip apparatus being selectively engageable with the extension rod apparatus and the wireframe of the wreath, the wreath clip apparatus comprising a fixed portion and a pivotable portion, the pivotable portion being spring-loaded.
